(19) United States
(12) Patent Application Publication
(10) Pub. No.: US 2005/0131931 A1
(43) Pub. Date: Jun. 16, 2005

(54) Abstract generation method and program product

(75) Inventor: Hiromitsu Kawajiri, Hashima-Gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/007,328

(22) Filed: Dec. 9, 2004

(30) Foreign Application Priority Data
Dec. 11, 2003 (JP) 2003-413649 (P)
Oct. 22, 2004 (JP) JP 2004-307723

(51) Int. Cl. G06F 17/00

(52) U.S. Cl. 707/101

(57) ABSTRACT

The present invention relates to an abstract generation method of generating an abstract from document information, such as an electronic patient chart, and a program product that implements the abstract generation method, and has an object to make it possible to display only main parts of sentences concisely and effectively. When document information (electronic patient chart, for instance) is inputted into a system, morphological analysis is performed on the document information and it is judged whether a part of a sentence matches the whole of another sentence. When a matching result is obtained, a partially matching character string is set as a simplified sentence candidate. On the other hand, when a matching result is not obtained, the sentence is set as a simplification candidate as it is. Note that even when the partially matching result is obtained, when the number of characters of the matching character string is less than M or when the number of morphemes thereof is less than N, the partially matching character string is not set as the simplified sentence candidate but the sentence is set as the simplification candidate as it is. Next, each simplification candidate containing a keyword is extracted from among generated simplification candidates and is set as a summary candidate. Then, an abstract is generated by marking each part of the input document corresponding to the summary candidate.

### BACKGROUND OF THE INVENTION

1. Field of the Invention

The present invention relates to an abstract generation method of generating an abstract from document information, such as an electronic patient chart, and a program product that implements the abstract generation method.

2. Description of the Related Art

When a large amount of document information is contained in one file, in order to make it possible to confirm the contents of each piece of document information with ease, an abstract is generated in many cases. For instance, a written abstract is generated separately using important parts excerpted from the document information or only the important parts in the document information are underlined or highlighted. With the abstract generated in this manner, it becomes possible to grasp the contents of each piece of document information with ease. In addition, it also becomes possible to extract desired document information from the file with ease.

When an abstract is generated from a document, such as an electronic patient chart, where the same expressions appear many times, it is effective that the abstract is generated by extracting sentences containing specific keywords. For instance, with a technique disclosed in JP H11-316762 A, an abstract of an e-mail is created by extracting sentences containing important expressions prepared in advance.

When sentences containing specific keywords are extracted in this manner, however, each sentence where its main part has the same contents but a clause expressing a date or a period, a conjunction, or the like is added before or after the main part is extracted. When an abstract is generated, however, such a clause expressing a date or a period, conjunction, or the like does not have a specifically important meaning and, if anything, makes the abstract difficult to read. Therefore, in order to generate an abstract that is easy to read and understand, it is preferable that only the main part of each sentence that does not contain a clause expressing a date or a period, a conjunction, or the like is concisely described in the abstract.

### SUMMARY OF THE INVENTION

It is therefore an object of the present invention to provide an abstract creation method, with which it is possible to display only the main parts of sentences concisely and effectively, and a program product that implements the abstract creation method.

According to a first aspect of the present invention, there is provided an abstract generation method of generating an abstract from document information, characterized by including: extracting each sentence containing a keyword as a key-sentence from among sentences contained in the document information; comparing a key-sentence and another key-sentence with each other and judging whether a part of the key-sentence matches the other key-sentence; setting a summary candidate in accordance with a result of the judgment; and generating an abstract based on each part of the document information corresponding to the summary candidate. Here, when it is judged that a part of the key-sentence matches the other key-sentence, a character string in the matching part is set as the summary candidate, and when it is not judged that a part of the key-sentence matches the other key-sentence, the key-sentence is set as the summary candidate.

According to a second aspect of the present invention, there is provided an abstract generation method of generating an abstract from document information, characterized by including: comparing one sentence and another sentence contained in the document information with each other and judging whether a part of the sentence matches the other sentence; setting a simplified sentence candidate in accordance with a result of the judgment; extracting each simplified sentence candidate containing a keyword from among simplified sentence candidates and setting the extracted simplified sentence candidate as a summary candidate; and generating an abstract based on each part of the document information corresponding to the summary candidate. Here, when it is judged that a part of the sentence matches the other sentence, a character string in the matching part is set as the simplified sentence candidate, and when it is not judged that a part of the sentence matches the other sentence, the sentence is set as the simplified sentence candidate.

According to a third aspect of the present invention, there is provided a program product that gives a summary generation function to a computer, characterized by including: an extraction processing portion that extracts each sentence containing a keyword as a key-sentence from among sentences contained in document information; a judgment processing portion that compares a key-sentence and another key-sentence with each other and judges whether a part of the key-sentence matches the other key-sentence; a setting processing portion that sets a summary candidate in accordance with a result of the judgment by the judgment processing portion; and a generation processing portion that generates an abstract based on each part of the document information corresponding to the summary candidate set in the setting processing portion. Here, the setting processing portion includes processing that sets, when the judgment processing portion has judged that a part of the key-sentence matches the other key-sentence, a character string in the matching part as the summary candidate, and sets, when the judgment processing portion has not judged that a part of the key-sentence matches the other key-sentence, the key-sentence as the summary candidate.

According to a fourth aspect of the present invention, there is provided a program product that gives a summary generation function to a computer, characterized by including: a judgment processing portion that compares a sentence and another sentence contained in document information and judges whether a part of the sentence matches the other sentence; a simplification processing portion that sets a simplified sentence candidate in accordance with a result of the judgment by the judgment processing portion; a setting processing portion that extracts each simplified sentence candidate containing a keyword from among simplified sentence candidates set by the simplification processing portion and sets the extracted simplified sentence candidate as a summary candidate; and a generation processing portion that generates an abstract based on each part of the document information corresponding to the summary candidate set by the setting processing portion. Here, the simplification processing portion includes processing that sets, when the judgment processing portion has judged that a part of the sentence matches the other sentence, a character string in the matching part as the simplified sentence candidate, and sets, when the judgment processing portion has not judged that a part of the sentence matches the other sentence, the sentence as the simplified sentence candidate.

According to the aspects of the present invention, among sentences containing a keyword, each sentence including a clause expressing a date or a period like “after that” or “in a month”, a conjunction, or the like is simplified into a sentence, in which the clause, conjunction, or the like has been removed, and is set as a summary candidate. As a result, it becomes possible to generate a concise and effective abstract where each unnecessary expression, such as a clause expressing a date or a period or a conjunction, has been omitted.

It should be noted here that in the present invention, the term “sentence” refers to a character string delimited by a line feed mark and the next line feed mark as well as a character string delimited by a period “.” and the next period “.”, or other type of character string delimited by other method. Also, as one abstract creation form in the abstract generation, it is possible to adopt a form where document information is displayed in its entirety and marking is performed on each character part corresponding to a summary candidate set in the summary candidate setting. Here, the term “marking” refers to a technique with which differentiation of displaying is achieved by changing the weight, size, color, and/or the like of each character string as well as a technique with which the character string is prominently displayed through underlining or highlighting.

### BRIEF DESCRIPTION OF THE DRAWINGS

The above and other objects and novel features of the present invention will become apparent more completely from the following description of embodiments to be made with reference to the accompanying drawings, wherein:

FIG. 1 shows a construction of an abstract creation apparatus according to a first embodiment;

FIG. 2 is a flowchart showing a processing operation of the abstract creation apparatus according to the first embodiment;

FIG. 3A shows a concrete example of an abstract creation operation according to the first embodiment;

FIG. 3B shows the concrete example of the abstract creation operation according to the first embodiment;

FIG. 3C shows the concrete example of the abstract creation operation according to the first embodiment;

FIG. 3D shows the concrete example of the abstract creation operation according to the first embodiment;

FIG. 4 shows a construction of an abstract creation apparatus according to a second embodiment;

FIG. 5 is a flowchart showing a processing operation of the abstract creation apparatus according to the second embodiment;

FIG. 6A shows a concrete example of an abstract creation operation according to the second embodiment;

FIG. 6B shows the concrete example of the abstract creation operation according to the second embodiment;

FIG. 6C shows the concrete example of the abstract creation operation according to the second embodiment;

FIG. 6D shows the concrete example of the abstract creation operation according to the second embodiment;

FIG. 7A shows a concrete example of an abstract creation operation according to a third embodiment;

FIG. 7B shows the concrete example of the abstract creation operation according to the third embodiment;

FIG. 7C shows the concrete example of the abstract creation operation according to the third embodiment;

FIG. 8 is a flowchart showing a processing operation of an abstract creation apparatus according to the third embodiment;

FIG. 9A shows a concrete example of an abstract creation operation according to a fourth embodiment;

FIG. 9B shows the concrete example of the abstract creation operation according to the fourth embodiment;

FIG. 9C shows the concrete example of the abstract creation operation according to the fourth embodiment; and

FIG. 10 is a flowchart showing a processing operation of an abstract creation apparatus according to the fourth embodiment.

### DETAILED DESCRIPTION OF THE PREFERRED EMBODIMENTS

Hereinafter, embodiments of the present invention will be described with reference to the accompanying drawings. It should be noted here that the following embodiments are merely examples of the present invention, and therefore there is no intention to specifically limit the scope of the present invention to the embodiments.

### First Embodiment

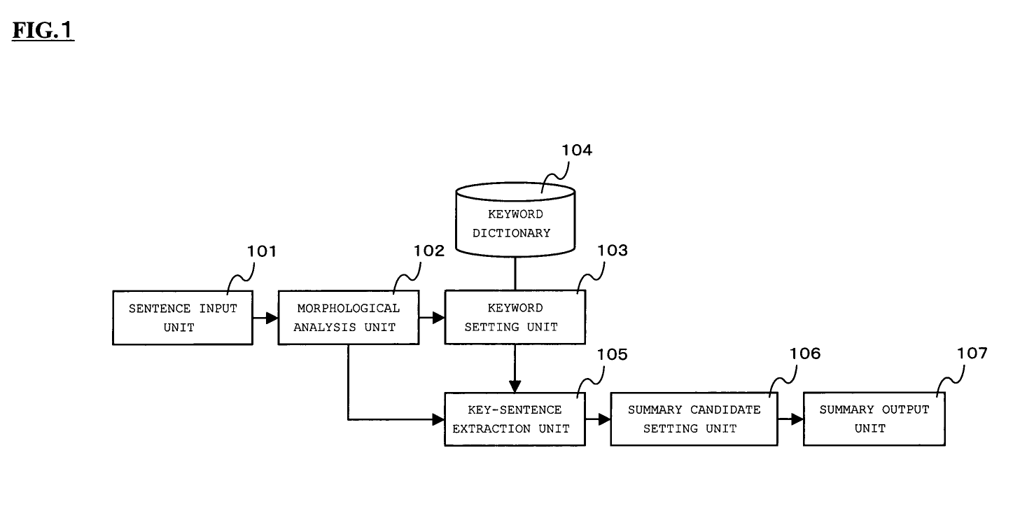

FIG. 1 shows a construction of an abstract creation apparatus according to a first embodiment.

It should be noted here that in terms of hardware, it is possible to realize the abstract creation apparatus in this embodiment using an arbitrary computer CPU, memory, LSI, and the like. Also, in terms of software, it is possible to realize the abstract creation apparatus in this embodiment with a program or the like loaded into a memory and having a recording control function. Functional blocks of the abstract creation apparatus shown in FIG. 1 are realized by hardware and software. Note that in order to realize these functional blocks, aside from the form where hardware and software are combined with each other, it is of course possible to use a form where only hardware or only software is used.

As shown in FIG. 1, the abstract creation apparatus includes a sentence input unit 101, a morphological analysis unit 102, a keyword setting unit 103, a keyword dictionary 104, a key-sentence extraction unit 105, a summary candidate setting unit 106, and a summary output unit 107.

The sentence input unit 101 receives document information, such as an electronic patient chart, from an input port, a disk drive, or the like. The morphological analysis unit 102 includes a database for morphological analysis with which it divides document information (document information in one unit) inputted from the input unit 101 into morphemes through morphological analysis, gives punctuation information and information showing whether the morphemes are each an independent word or an adjunct to the document information, and outputs them to the keyword setting unit 103 and the key-sentence extraction unit 105.

The keyword setting unit 103 detects the occurrence frequency of each independent word contained in the document information and stores each independent word, whose occurrence frequency is equal to or more than a predetermined threshold value, as a keyword candidate in a memory (not shown). When doing so, for the keyword candidate, a score corresponding to the occurrence frequency is set and is stored in the memory.

In the keyword dictionary 104, each keyword candidate set by a user using an input means, such as a keyboard, in advance is stored. When the user sets the keyword candidate, he/she sets an importance for the keyword candidate. In the keyword dictionary 104, a score corresponding to the importance is stored so as to be associated with the keyword.

The keyword setting unit 103 generates a keyword table from the keyword candidate stored in the memory and the keyword candidate registered in the keyword dictionary 104. This keyword table is referred to at the time of key-sentence extraction by the key-sentence extraction unit 105.

It should be noted here that for instance, the keyword table is generated from every keyword candidate registered in the keyword dictionary 104 and keyword candidates with several top-ranked scores among the keyword candidates stored in the memory. Alternatively, the keyword table may be generated from keyword candidates with several top-ranked importance among the keyword candidates registered in the keyword dictionary 104 and keyword candidates with several top-ranked scores among the keyword candidates stored in the memory. Here, it is preferable that the lowest rank of the keyword candidates to be registered in the keyword table can be set by the user as appropriate.

The key-sentence extraction unit 105 extracts each sentence, which contains any of the keywords in the keyword table set by the keyword setting unit 103 as morphemes, as a key-sentence candidate from among sentences contained in the input document and outputs it to the summary candidate setting unit 106. Note that in this embodiment, for instance, the key-sentence candidate extraction is performed by setting a character string from a period “.” to the next period “.” as one sentence. Alternatively, a character string from a line feed mark to the next line feed mark may be set as one sentence.

The summary candidate setting unit 106 compares a key-sentence candidate with another key-sentence candidate inputted from the key-sentence extraction unit 105. Following this, when the key-sentence candidate partially contains the other key-sentence candidate, the summary candidate setting unit 106 sets a character string in the matching part as a summary candidate. On the other hand, when the key-sentence candidate does not partially contain the other key-sentence candidate, the summary candidate setting unit 106 sets the key-sentence candidate as a summary candidate as it is. Note that when the number of characters of the character string in the matching part is less than the minimum number of characters M set in advance or when the number of morphemes of the character string is less than the minimum number of morphemes N set in advance, the summary candidate setting unit 106 does not set the character string in the matching part as a summary candidate but sets the key-sentence candidate as a summary candidate as it is.

The summary output unit 107 generates an abstract from the document information and displays it on a monitor. For instance, the summary output unit 107 displays the inputted document information in its entirety and also marks (underlines or highlights, for instance) each character string matching a summary candidate set by the summary candidate setting unit 106. Alternatively, a format for summary may be prepared separately and each character string matching a summary candidate may be moved to the format.

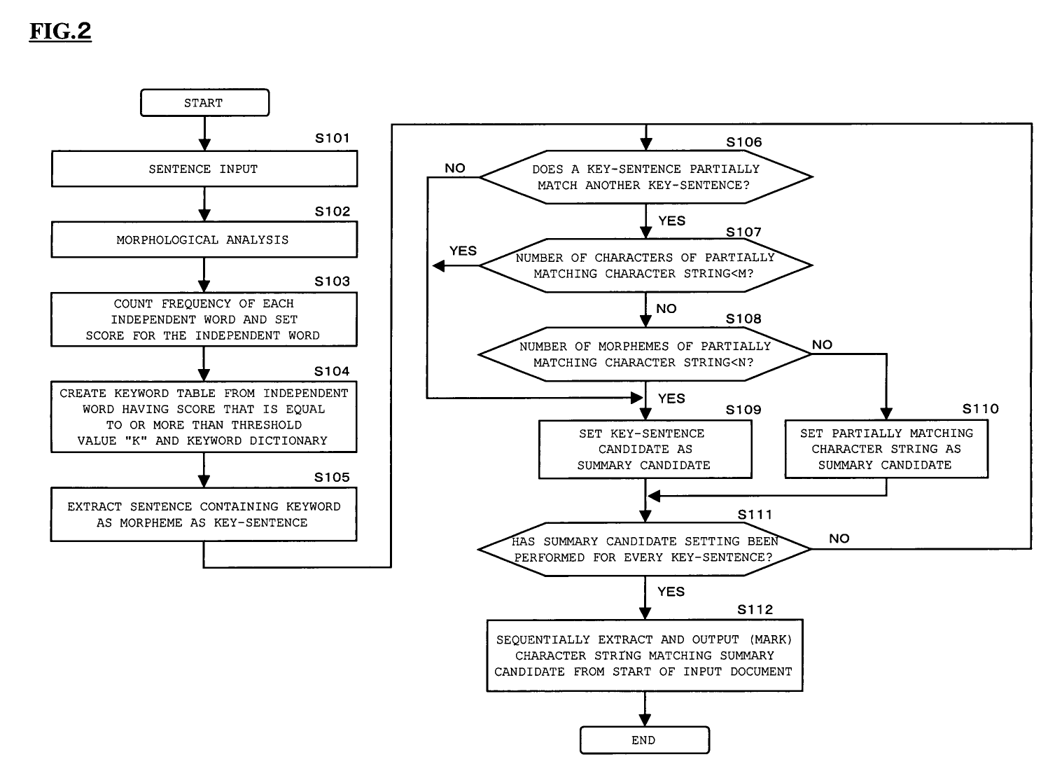

FIG. 2 shows a processing flow of the abstract creation apparatus in this embodiment.

First, in step S101, the sentence input unit 101 receives input of document information. Next, in step S102, the morphological analysis unit 102 subjects the inputted document information to morphological analysis. Then, in step S103, the keyword setting unit 103 counts the frequency of each independent word and sets a score for the independent word in accordance with the frequency. Following this, in step S104, the keyword setting unit 103 generates a keyword table from each independent word (keyword candidate) having a score that is equal to or more than a threshold value K and each independent word (keyword candidate) registered in the keyword dictionary 104. Then, in step S105, the key-sentence extraction unit 105 extracts each sentence, which contains any of the keywords in the generated keyword table as morphemes, as a key-sentence candidate.

After key-sentence candidates are extracted from the input document in this manner, next, in steps S106 to S111, the summary candidate setting unit 106 carries out summary candidate setting processing described above. In more detail, first, in step S106, the summary candidate setting unit 106 compares a key-sentence candidate that is a judgment target with another key-sentence candidate and judges whether the key-sentence candidate partially contains (partially matches) the other key-sentence candidate. Next, when a partial matching result is not obtained, the processing proceeds to step S109, in which the summary candidate setting unit 106 sets the key-sentence candidate that is the judgment target as a summary candidate as it is.

On the other hand, when a partially matching result is obtained, the processing proceeds to step S107, in which the summary candidate setting unit 106 judges whether the number of characters of a character string in the partially matching part is less than a set value M. Following this, when the number of characters is less than the set value M, the processing proceeds to step S109, in which the summary candidate setting unit 106 sets the key-sentence candidate that is the judgment target as a summary candidate as it is. On the other hand, when the number of characters is equal to or more than the set value M, the processing proceeds to step S108, in which the summary candidate setting unit 106 next judges whether the number of morphemes of the character string in the partially matching part is less than a set value N. Next, when the number of morphemes is less than the set value N, the processing proceeds to step S109, in which the summary candidate setting unit 106 sets the key-sentence candidate that is the judgment target as a summary candidate as it is. On the other hand, when the number of morphemes is equal to or more than N, the processing proceeds to step S110, in which the summary candidate setting unit 106 sets the partially matching character string as a summary candidate.

Then, in step S111, the summary candidate setting unit 106 judges whether it has performed the summary candidate setting processing for every key-sentence candidate. Following this, when the summary candidate setting processing has not yet been performed for every key-sentence candidate, the summary candidate setting unit 106 repeats the operations in steps S106 to S110 described above. On the other hand, when the summary candidate setting processing has been performed for every key-sentence candidate, the processing proceeds to step S112, in which the summary output unit 107 performs summary output processing based on summary candidates. For instance, the summary output unit 107 displays the inputted document information in its entirety and also marks (underlines or highlights, for instance) each character string matching a summary candidate set in steps S106 to S111 described above.

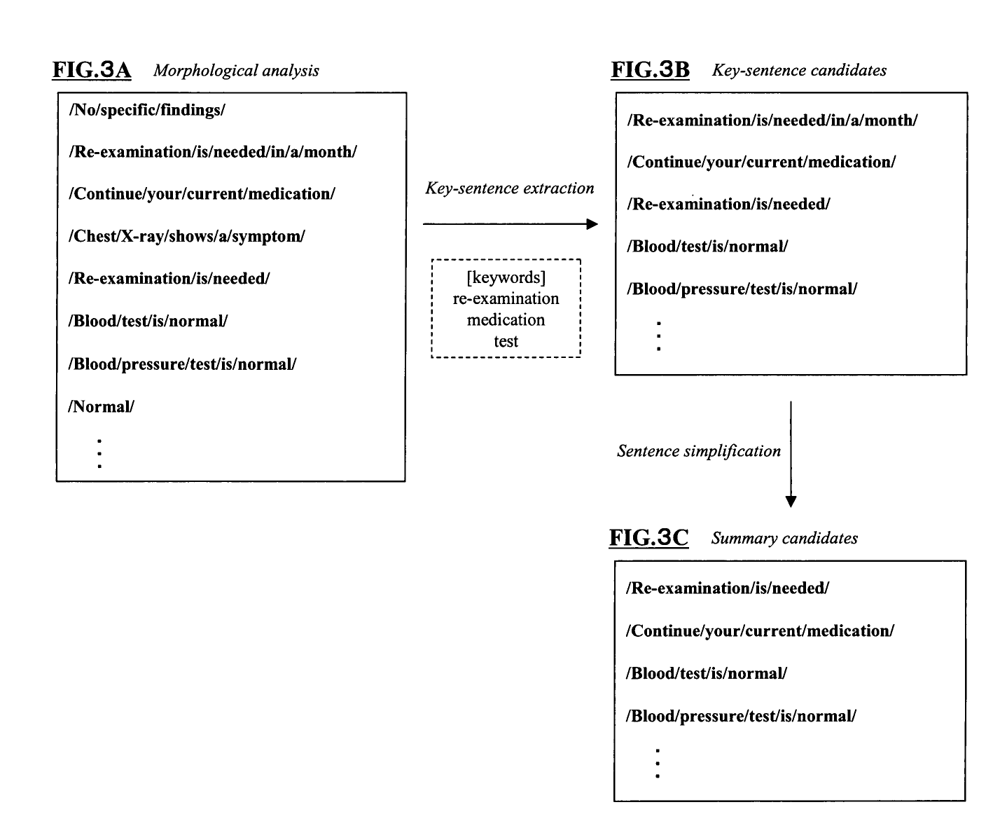

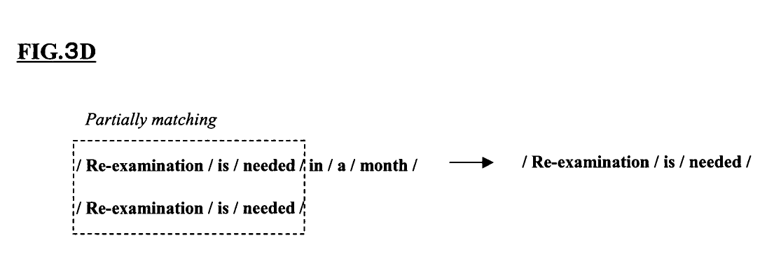

FIGS. 3A to 3D show a concrete processing example at the time of the summary candidate setting.

When document information in one unit (electronic patient chart, for instance) is inputted into the input unit, the document information is subjected to morphological analysis, as shown in FIG. 3A. Note that in the drawings, the sign “/” indicates the delimitations of morphemes. Following this, when “re-examination”, “medication”, and “test” are set as keywords in the keyword table, only each sentence containing any of “re-examination”, “medication”, and “test” as morphemes is extracted from among sentences contained in the document and is set as a key-sentence candidate, as shown in FIG. 3B.

Next, it is judged whether a part of a key-sentence candidate matches another key-sentence candidate (whether a key-sentence candidate partially matches another key-sentence candidate) and, when a matching result is obtained, the partially matching character string is set as a summary candidate. For instance, among the key-sentence candidates shown in FIG. 3B, “Re-examination is needed in a month” partially matches “Re-examination is needed”, as shown in FIG. 3D. Consequently, “Re-examination is needed” is set as a summary candidate.

On the other hand, when a partially matching result is not obtained, the key-sentence candidate is set as a summary candidate as it is. For instance, among the key-sentence candidates shown in FIG. 3B, “Blood test is normal” overlaps “Blood pressure test is normal” in a part “test is normal”, however, this sentence does not contain the whole of “Blood pressure test is normal” as its part, so a partially matching result is not obtained. Consequently, as shown in FIG. 3C, “Blood test is normal” is set as a summary candidate as it is. The same applies to “Blood pressure test is normal”.

As described above, in this embodiment, among sentences containing keywords (key-sentence candidates), each sentence including a clause expressing a date or a period like “in a month”, a conjunction, or the like is simplified into a sentence, from which the clause, conjunction, or the like has been removed, and is set as a summary candidate. As a result, it becomes possible to generate and output an abstract where there exists no unnecessary expression such as a date, a period, or a clause.

Also, although not illustrated in FIGS. 3A to 3D, when the number of characters in a partially matching part is less than the minimum number of characters M or when the number of morphemes in the partially matching part is less than the minimum number of morphemes N, processing is performed, in which the partially matching character string is not set as a summary candidate but the key-sentence candidate is set as a summary candidate. As a result, it becomes possible to prevent a situation where the key-sentence candidate is excessively simplified, which makes it possible to generate and output an abstract (summary) that has been simplified by an appropriate degree and gives information sufficient for contents grasping.

It should be noted here that the minimum number of characters M and the minimum number of morphemes N are, for instance, set by a designer at a design stage by performing summary generation on a trial basis while changing these numbers M and N as values with which it is possible to output the most effective summary. Alternatively, these values may be set so as to be settable by a user as appropriate.

### Second Embodiment

In the first embodiment described above, after key-sentence candidates are extracted based on keywords, these key-sentences are simplified and are set as summary candidates. In a second embodiment, sentences contained in an input document are first simplified and then simplified sentences containing keywords are extracted and are set as summary candidates.

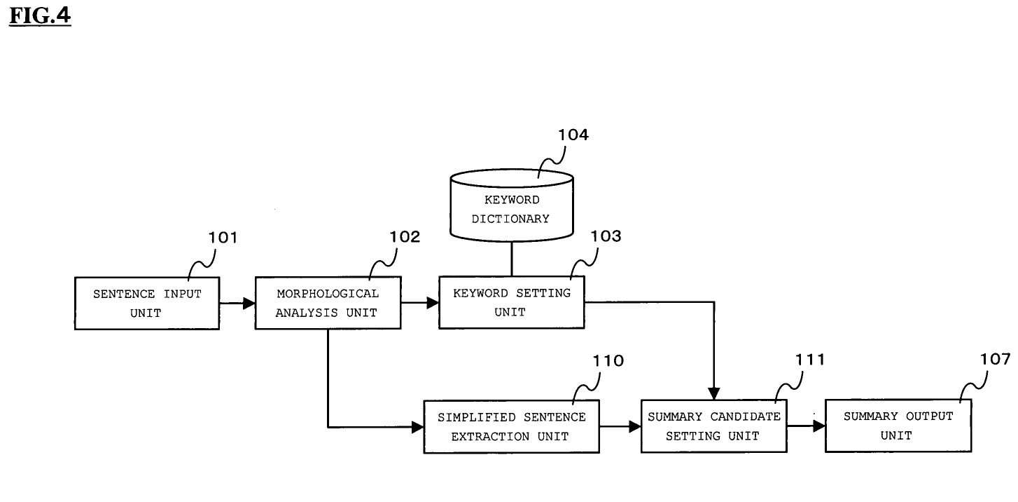

FIG. 4 shows a construction of a summary generation apparatus according to the second embodiment.

In FIG. 4, the functions of a sentence input unit 101, a morphological analysis unit 102, a keyword setting unit 103, a keyword dictionary 104, and a summary output unit 107 are the same as those shown in FIG. 1 described above. In this embodiment, in place of the key-sentence extraction unit 105 and the summary candidate setting unit 106 in the first embodiment described above, a simplified sentence extraction unit 110 and a summary candidate setting unit 111 are used.

The simplified sentence extraction unit 110 compares a sentence with another sentence among sentences contained in an input document. Following this, when the sentence partially matches the other sentence, the simplified sentence extraction unit 110 sets a character string in the matching part as a simplified sentence candidate. On the other hand, when the sentence does not partially match the other sentence, the simplified sentence extraction unit 110 sets the sentence as a simplified sentence candidate as it is. However, when the number of characters of the character string in the matching part is less than the minimum number of characters M set in advance or when the number of the morphemes of the character string is less than the minimum number of morphemes N set in advance, the simplified sentence extraction unit 110 does not set the character string in the matching part as a simplified sentence candidate but sets the sentence as a simplified sentence candidate as it is.

The summary candidate setting unit 111 extracts each sentence containing any of keywords in a keyword table set by the keyword setting unit 103 as morphemes from among the generated simplified sentence candidates and sets the extracted sentence as a summary candidate.

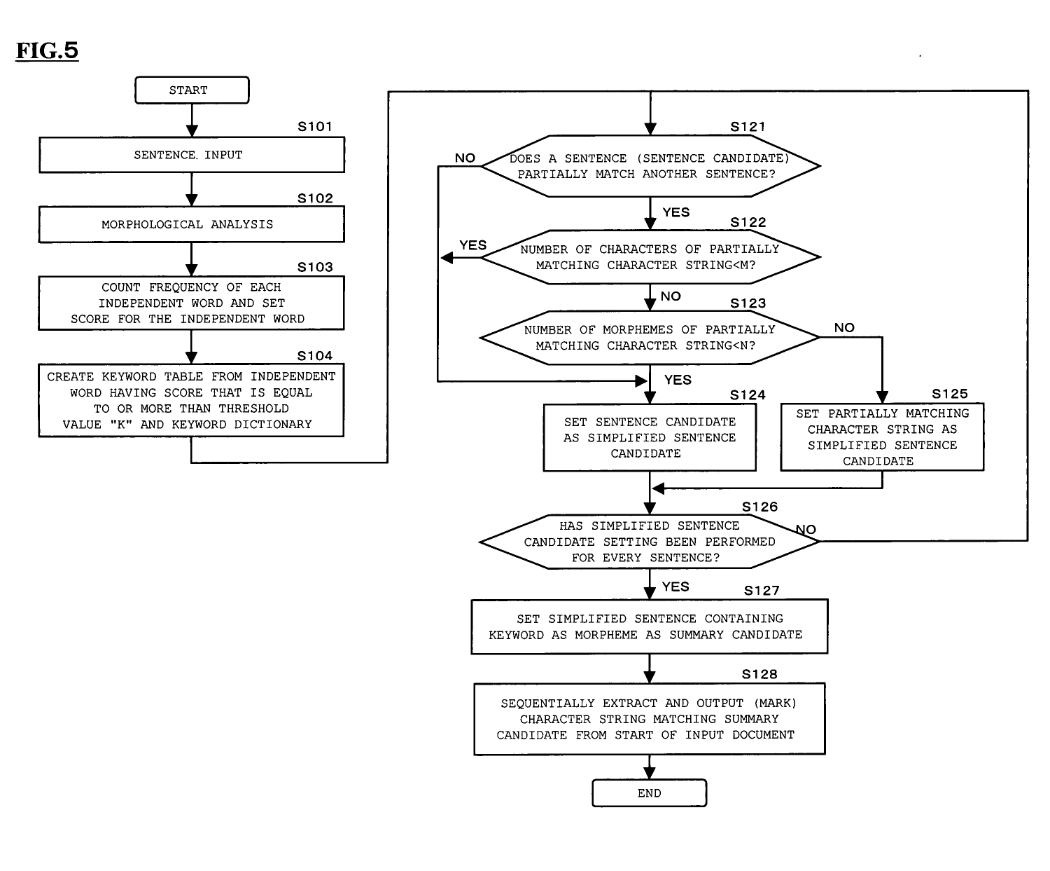

FIG. 5 shows a processing flow of the abstract creation apparatus in this embodiment.

It should be noted here that in the processing flow shown in FIG. 5, steps S101 to S104 are the same as those in the processing flow shown in FIG. 2 in the first embodiment described above, so the description thereof will be omitted.

In step S104, a keyword table is generated. Next, in step S121, among sentences contained in an input document, a sentence (sentence candidate) is compared with another sentence, and it is judged whether the sentence candidate partially contains (partially matches) the other sentence. Next, when a partially matching result is not obtained, the processing proceeds to step S124, in which the sentence candidate is set as a simplified sentence candidate as it is.

On the other hand, when a partially matching result is obtained, the processing proceeds to step S122, in which it is judged whether the number of characters of a character string in a partially matching part is less than a set value M. Next, when the number of characters is less than the set value M, the processing proceeds to step S124, in which the sentence candidate is set as a simplified sentence candidate as it is. On the other hand, when the number of characters is equal to or more than the set value M, the processing proceeds to step S123, in which it is next judged whether the number of morphemes of the character string in the partially matching part is less than a set value N. Next, when the number of morphemes is less than the set value N, the processing proceeds to step S124, in which the sentence candidate is set as a simplified sentence candidate as it is. On the other hand, when the number of morphemes is equal to or more than N, the processing proceeds to step S125, in which the partially matching character string is set as a simplified sentence candidate.

Then, in step S126, it is judged whether the simplified sentence candidate generation processing has been performed for every sentence. Following this, when the simplified sentence candidate generation processing has not yet been performed for every sentence, the operations in steps S121 to S125 described above are repeated. On the other hand, when the simplified sentence candidate generation processing has been performed for every sentence, the processing proceeds to step S127, in which each simplified sentence candidate containing any of the keywords in the keyword table generated in step S104 as morphemes is extracted from among simplified sentence candidates and is set as a summary candidate. Then, in step S128, the summary output unit 107 performs abstract output processing based on each set summary candidate. For instance, the summary output unit 107 displays the inputted document information in its entirety and also marks (underlines or highlights, for instance) each character string matching a summary candidate set in steps S121 to S127 described above.

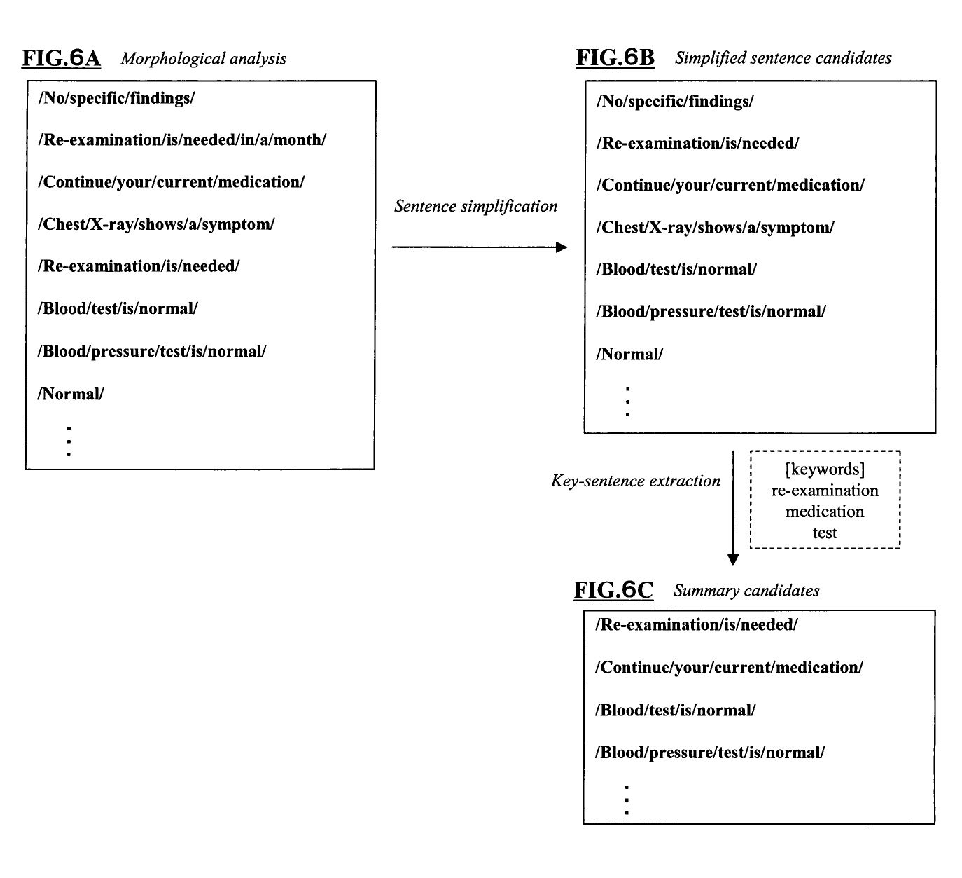

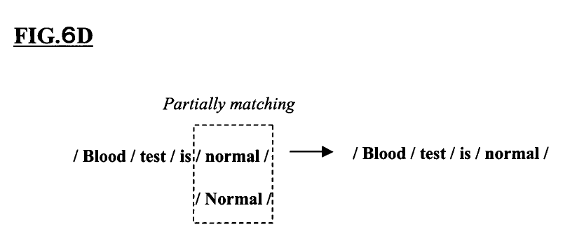

FIGS. 6A to 6D show a concrete processing example at the time of the summary candidate setting.

When document information in one unit (electronic patient chart, for instance) is inputted into the input unit, the inputted document information is subjected to morphological analysis, as shown in FIG. 6A. After the morphological analysis, it is judged whether a part of a sentence matches another sentence (whether a sentence partially matches another sentence). Following this, when a matching result is obtained, the partially matching character string is set as a simplified sentence candidate. On the other hand, when a matching result is not obtained, the sentence is set as a simplification candidate as it is.

For instance, among the sentences shown in FIG. 6A, “Re-examination is needed in a month” partially matches “Re-examination is needed”. Consequently, “Re-examination is needed” is set as a simplified sentence candidate.

It should be noted here that among the sentences shown in FIG. 6A, “Blood test is normal” and “Blood pressure test is normal” partially match “normal”, however, the number of characters in the partially matching part is less than the minimum value M (M=10, for instance), so simplified sentence candidates of “Blood test is normal” and “Blood pressure test is normal” will never be set as “normal”, as shown in FIG. 6D. Consequently, “Blood test is normal”, “Blood pressure test is normal”, and “normal” are each set as a simplification candidate as it is.

Next, each simplification candidate containing any of the keywords is extracted from among the generated simplification candidates and is set as a summary candidate. For instance, when “re-examination”, “medication”, and “test” are set as keywords in the keyword table, only each simplification candidate containing any of “re-examination”, “medication”, and “test” as morphemes is extracted from among the simplification candidates shown in FIG. 6B and is set as a summary candidate, as shown in FIG. 6C.

As described above, in this embodiment, like in the first embodiment described above, it becomes possible to generate and output an abstract where there exists no unnecessary expression such as a date, a period, or a conjunction. Also, by setting the minimum number of characters M and the minimum number of morphemes N, it becomes possible to prevent excess simplification, which makes it possible to generate and output an effectively simplified abstract.

### Third Embodiment

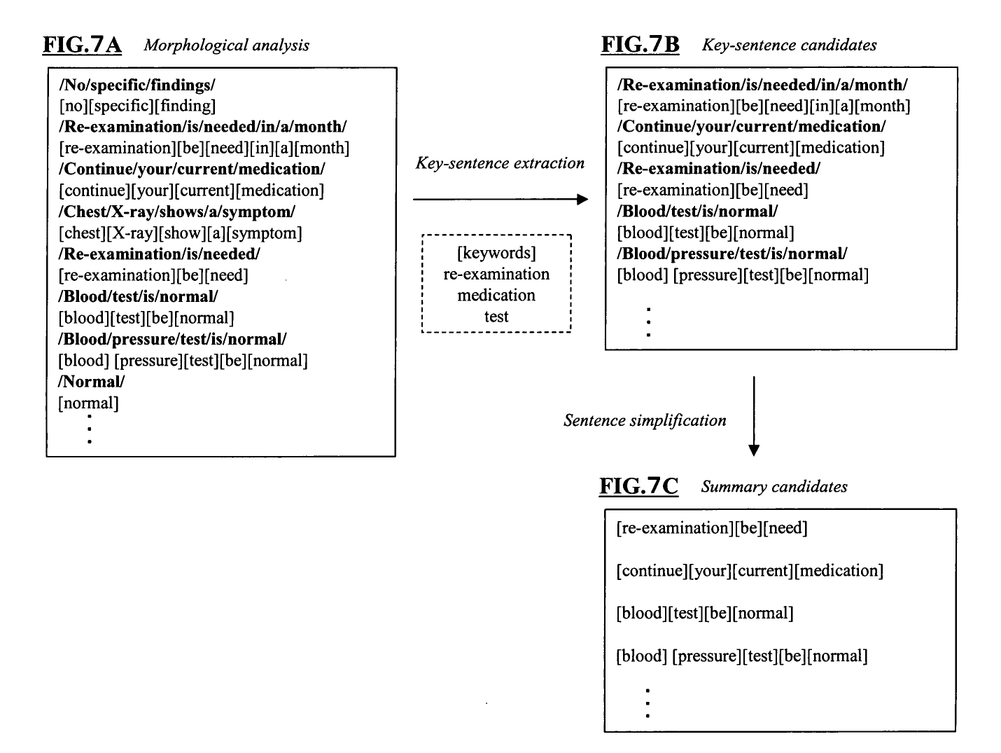

In the first embodiment described above, key-sentence candidates are extracted by comparing morphemes obtained through morphological analysis of document information with keywords (see FIG. 3B) and summary candidates are further extracted by comparing morphemes contained in the extracted key-sentence candidates between the key-sentences (see FIG. 3C). In contrast to this, in a third embodiment, the original forms of morphemes in document information are simultaneously obtained together with the morphemes (see FIG. 7A), and key-sentence candidates are extracted by comparing the morphemes and their original forms with keywords (see FIG. 7B). Then, summary candidates are extracted by comparing the morphemes contained in the extracted key-sentence candidates and their original forms between the key-sentence candidates (see FIG. 7C). In FIGS. 7A to 7C, the original forms of morphemes are indicated with brackets.

In this embodiment, the function of each block of the abstract creation apparatus shown in FIG. 1 is changed as follows.

The morphological analysis unit 102 includes a table, in which the original form and changed forms of each word are associated with each other, in addition to a database for morphological analysis. Like in the first embodiment described above, the morphological analysis unit 102 divides document information in one unit inputted from the input unit 101 into morphemes and gives punctuation information and information showing whether the morphemes are each an independent word or an adjunct to the document information. When doing so, at the same time, each morpheme is given information concerning its original form while referring to the table described above.

The keyword setting unit 103 detects the occurrence frequency of the original form of each independent word contained in the document information and stores the original form of each independent word, whose occurrence frequency is equal to or more than a predetermined threshold value, as a keyword candidate in a memory (not shown). When doing so, for the keyword candidate, a score corresponding to the occurrence frequency is set and is stored in the memory.

The keyword setting unit 103 generates a keyword table from the keyword candidates (original forms of independent words) stored in the memory and keyword candidates registered in the keyword dictionary 104. This keyword table is referred to at the time of key-sentence extraction by the key-sentence extraction unit 105. Like in the first embodiment described above, the keyword table is, for instance, generated from every keyword candidate registered in the keyword dictionary 104 and keyword candidates with several top-ranked scores among the keyword candidates (original forms of independent words) stored in the memory.

The key-sentence extraction unit 105 extracts each sentence, which contains any of the keywords in the keyword table set by the keyword setting unit 103 as morphemes or their original forms, as a key-sentence candidate from among sentences contained in an input document. Then, the key-sentence extraction unit 105 outputs the morphemes contained in the key-sentence candidate and their original forms to the summary candidate setting unit 106.

The summary candidate setting unit 106 compares a key-sentence candidate with another key-sentence candidate inputted from the key-sentence extraction unit 105 and judges whether the key-sentence candidate partially contains the other key-sentence candidate. This judgment is made by comparing the two target key-sentence candidates as to morphemes and their original forms. Next, when judging that the key-sentence candidate that is a judgment target partially contains the other key-sentence candidate in terms of morphemes or their original forms, the summary candidate setting unit 106 sets the original forms of a character string in the matching part as a summary candidate. On the other hand, when the key-sentence candidate that is the judgment target does not partially contain the other key-sentence candidate in terms of morphemes or their original forms, the summary candidate setting unit 106 sets the original forms of morphemes contained in the key-sentence candidate as a summary candidate.

However, like in the first embodiment described above, when the number of characters of the character string in the matching part is less than the minimum number of characters M set in advance or when the number of morphemes of the character string is less than the minimum number of morphemes N set in advance, the summary candidate setting unit 106 does not set the character string in the matching part as a summary candidate but sets the original forms of the morphemes contained in the key-sentence candidate as a summary candidate.

The summary output unit 107 generates an abstract from the document information and displays it on a monitor. For instance, the summary output unit 107 displays the inputted document information in its entirety and also marks (underlines or highlights, for instance) each character string whose original forms match a summary candidate (original forms of morphemes) set by the summary candidate setting unit 106. Aside from this form, a format for summary may be prepared separately, and each character string, whose original forms match a summary candidate, may be moved to the format.

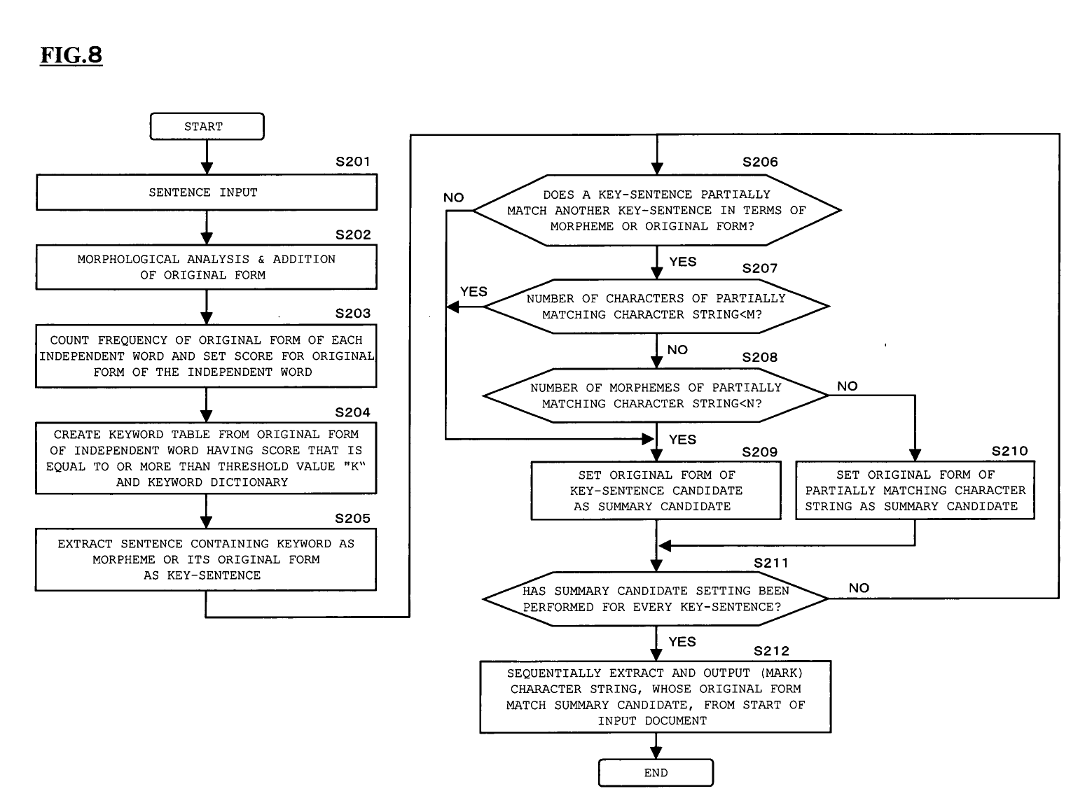

FIG. 8 shows a processing flow of the abstract creation apparatus in this embodiment.

In step S201, the sentence input unit 101 receives input of document information. Then, in step S202, the morphological analysis unit 102 subjects the inputted document information to morphological analysis and also adds the original form of each morpheme to the document information. Then, in step S203, the keyword setting unit 103 counts the frequency of the original form of each independent word and sets a score corresponding to the frequency for the original form of the independent word. Next, in step S204, the keyword setting unit 103 generates the keyword table from the original form (keyword candidate) of each independent word having a score that is equal to or more than a threshold value K and the independent words (keyword candidates) registered in the keyword dictionary 104. Then, in step S205, the key-sentence extraction unit 105 extracts each sentence containing any of the keywords in the generated keyword table as morphemes or their original forms as a key-sentence candidate.

After key-sentence candidates are extracted from the input document in this manner, next, in steps S206 to S211, the summary candidate setting unit 106 carries out summary candidate setting processing described above. In more detail, first, in step S206, the summary candidate setting unit 106 compares a key-sentence candidate that is a judgment target with another key-sentence candidate and judges whether the key-sentence candidate partially contains (partially matches) the other key-sentence candidate in terms of morpheme or its original form. Next, when a partial matching result is not obtained, the processing proceeds to step S209, in which the summary candidate setting unit 106 sets the original form of the morpheme contained in the key-sentence candidate that is the judgment target as a summary candidate as it is.

On the other hand, when a partially matching result is obtained, the processing proceeds to step S207, in which the summary candidate setting unit 106 judges whether the number of characters of a character string in the partially matching part is less than a set value M. Following this, when the number of characters is less than the set value M, the processing proceeds to step S209, in which the summary candidate setting unit 106 sets the original form of the morpheme contained in the key-sentence candidate that is the judgment target as a summary candidate. On the other hand, when the number of characters is equal to or more than the set value M, the processing proceeds to step S208, in which the summary candidate setting unit 106 next judges whether the number of morphemes of the character string in the partially matching part is less than a set value N. Next, when the number of morphemes is less than the set value N, the processing proceeds to step S209, in which the summary candidate setting unit 106 sets the original form of the morpheme contained in the key-sentence candidate that is the judgment target as a summary candidate as it is. On the other hand, when the number of morphemes is equal to or more than N, the processing proceeds to step S210, in which the summary candidate setting unit 106 sets the original form of the partially matching character string as a summary candidate.

Then, in step S211, the summary candidate setting unit 106 judges whether it has performed the summary candidate setting processing for every key-sentence candidate. Following this, when the summary candidate setting processing has not yet been performed for every key-sentence candidate, the summary candidate setting unit 106 repeats the operations in steps S206 to S210 described above. On the other hand, when the summary candidate setting processing has been performed for every key-sentence candidate, the processing proceeds to step S212, in which the summary output unit 107 performs summary output processing based on summary candidates. For instance, the summary output unit 107 displays the inputted document information in its entirety and also marks (underlines or highlights, for instance) each character string, which original form matches a summary candidate set in steps S206 to S211 described above.

According to this embodiment, each key-sentence candidate is extracted by comparing morphemes in document information and their original forms with keywords. As a result, even when morphemes in forms, in which the keywords have been changed from their original forms, are contained in the document information, it becomes possible to extract each sentence containing any of the morphemes that are in the changed forms of keywords as a key-sentence candidate. Note that in the above description, the keyword candidates registered in the keyword dictionary 104 are registered in the keyword table as they are, however instead of this form, the original forms of the keyword candidates may be registered in the keyword table. With this construction, it becomes possible to include each sentence, which a user wishes to insert in a summary, as a key-sentence candidate with more reliability.

Also, according to this embodiment, each summary candidate is extracted by comparing morphemes in document information and their original forms between key-sentence candidates. As a result, even when morphemes contained in the key-sentence candidates have been changed from their original forms (for instance, a lowercase letter has been changed to an uppercase letter or a singular form has been changed to a plural form), it becomes possible to make a precise judgment as to matching between the key-sentence candidates. As a result, it becomes possible to perform the simplification of the key-sentence candidates more smoothly.

### Fourth Embodiment

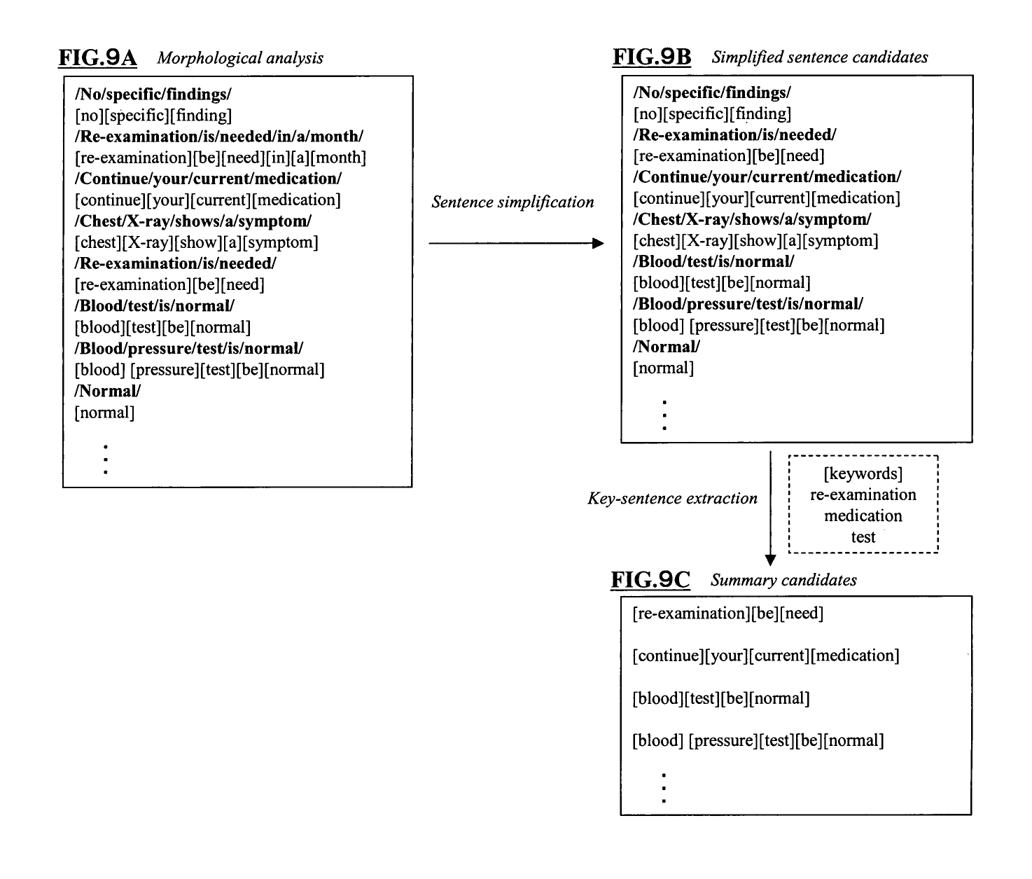

In the second embodiment described above, simplified sentence candidates are extracted by comparing morphemes obtained through morphological analysis of document information between sentences (see FIG. 6B), and summary candidates are further extracted by comparing the morphemes contained in the extracted simplified sentence candidates with keywords (see FIG. 6C). In contrast to this, in a fourth embodiment, the original forms of morphemes of document information are simultaneously obtained together with the morphemes (see FIG. 9A), and simplified sentence candidates are extracted by comparing the morphemes and their original forms between sentences (see FIG. 9B). Then, summary candidates are extracted by comparing morphemes contained in the extracted simplified sentence candidates and their original forms with keywords (see FIG. 9C). In FIGS. 9A to 9C, the original forms of morphemes are indicated with brackets.

In this embodiment, the function of each block of the abstract creation apparatus shown in FIG. 4 is changed as follows.

The functions of the morphological analysis unit 102 and the keyword setting unit 103 are changed in the same manner as in the case of the third embodiment described above. Note that the functions of the document input unit 101 and the keyword dictionary 104 are the same as those in the case of the second embodiment described above.

The simplified sentence extraction unit 110 compares a sentence with another sentence among sentences contained in an input document. Then, when the sentence partially matches the other sentence in terms of morphemes or their original forms, the simplified sentence extraction unit 110 sets a character string in the matching part and its original forms as a simplified sentence candidate. On the other hand, when a partially matching result is not obtained, the simplified sentence extraction unit 110 sets morphemes contained in the sentence and their original forms as a simplified sentence candidate. However, when the number of characters of the character string in the matching part is less than the minimum number of characters M set in advance or when the number of morphemes of the character string is less than the minimum number of morphemes N set in advance, the simplified sentence extraction unit 110 does not set the character string in the matching part as a simplified sentence candidate but sets the morphemes contained in the sentence and their original forms as a simplified sentence candidate.

The summary candidate setting unit 111 extracts each simplified sentence candidate containing any of the keywords in the keyword table set by the keyword setting unit 103 as morphemes or their original forms from among generated simplified sentence candidates and sets the original forms of the extracted simplified sentence candidate as a summary candidate.

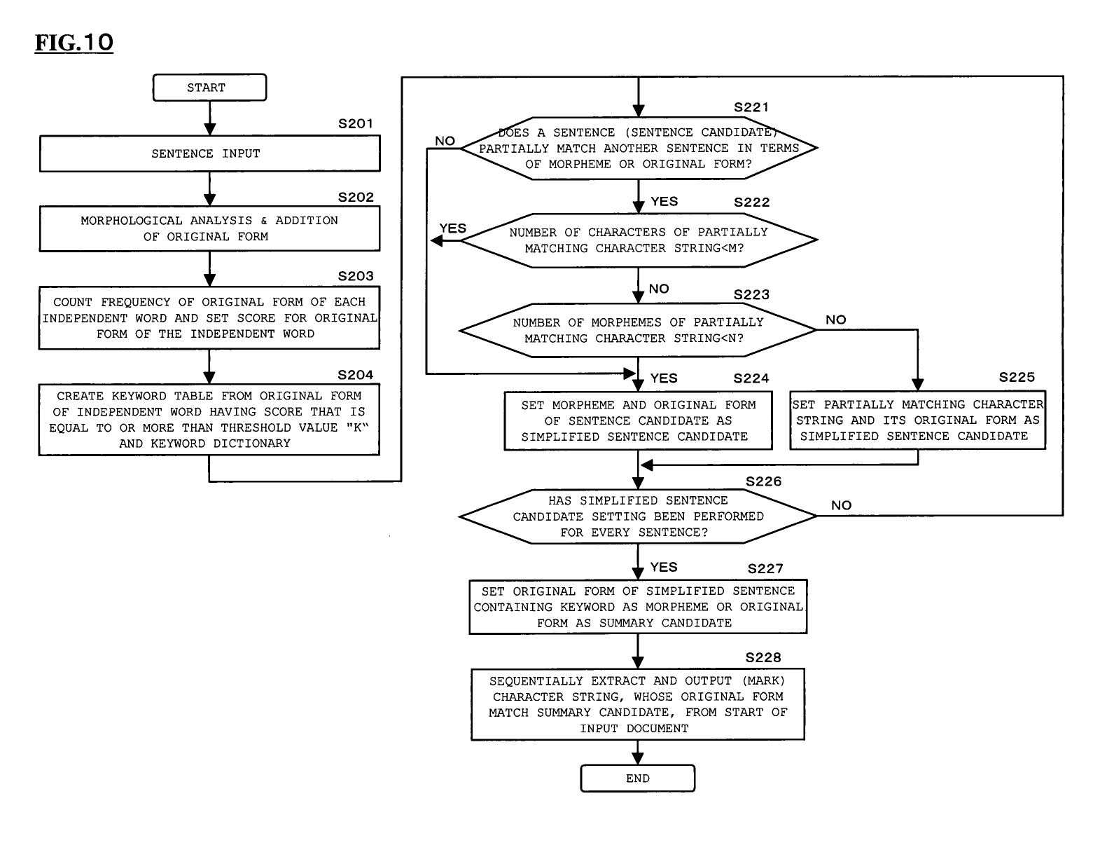

FIG. 10 shows a processing flow of the abstract creation apparatus in this embodiment.

It should be noted here that in the processing flow shown in FIG. 10, steps S201 to S204 are the same as those in the processing flow shown in FIG. 8 in the third embodiment described above, so the description thereof will be omitted.

In step S204, a keyword table is generated. Next, in step S221, among sentences contained in an input document, a sentence (sentence candidate) is compared with another sentence and it is judged whether the sentence candidate partially contains (partially matches) the other sentence in terms of morphemes or their original forms. Next, when a partially matching result is not obtained, the processing proceeds to step S224, in which each morpheme contained in the sentence candidate and its original form are set as a simplified sentence candidate.

On the other hand, when a partially matching result is obtained, the processing proceeds to step S222, in which it is judged whether the number of characters of a character string in the partially matching part is less than a set value M. Next, when the number of characters is less than the set value M, the processing proceeds to step S224, in which each morpheme contained in the sentence candidate and its original form are set as a simplified sentence candidate. On the other hand, when the number of characters is equal to or more than the set value M, the processing proceeds to step S223, in which it is next judged whether the number of morphemes of the character string in the partially matching part is less than a set value N. Next, when the number of morphemes is less than the set value N, the processing proceeds to step S224, in which each morpheme contained in the sentence candidate and its original form are set as a simplified sentence candidate. On the other hand, when the number of morphemes is equal to or more than N, the processing proceeds to step S225, in which the partially matching character string and its original forms are set as a simplified sentence candidate.

Then, in step S226, it is judged whether the simplified sentence candidate generation processing has been performed for every sentence. Following this, when the simplified sentence candidate generation processing has not yet been performed for every sentence, the operations in steps S221 to S225 described above are repeated. On the other hand, when the simplified sentence candidate generation processing has been performed for every sentence, the processing proceeds to step S227, in which each simplified sentence candidate containing any of the keywords in the keyword table generated in step S204 as morphemes or their original forms is extracted from among simplified sentence candidates and the original forms of the extracted simplified sentence candidate are set as a summary candidate. Then, in step S228, the summary output unit 107 performs abstract output processing based on each set summary candidate. For instance, the summary output unit 107 displays the inputted document information in its entirety and also marks (underlines or highlights, for instance) each character string whose original forms match a summary candidate set in steps S221 to S227 described above.

According to this embodiment, each simplified sentence candidate is extracted by comparing morphemes in document information and their original forms between sentences. As a result, even when morphemes contained in the sentences have been changed from their original forms (for instance, a lowercase letter has been changed to an uppercase letter or a singular form has been changed to a plural form), it becomes possible to make a precise judgment as to matching between the sentences. As a result, it becomes possible to perform the simplification of the sentences more smoothly.

Also, according to this embodiment, each summary candidate is extracted by comparing morphemes in simplified sentence candidates and their original forms with the keywords. As a result, even when morphemes in forms, in which the keywords have been changed from their original forms, are contained in the simplified sentence candidates, it becomes possible to extract each simplified sentence candidate containing any of the morphemes that are in the changed forms of keywords as a summary candidate. Note that in the above description, the keyword candidates registered in the keyword dictionary 104 are registered in the keyword table as they are, although instead of this form, the original forms of the keyword candidates may be registered in the keyword table. With this construction, it becomes possible to extract each sentence, which a user wishes to insert in a summary, as a key-sentence candidate with more reliability.

The present invention is not limited to the embodiments described above and it is possible to make various changes. For instance, in each embodiment described above, the morphemes are set as words, although the morphological analysis may be performed by setting the morphemes as word groups, such as “blood pressure” and “after all”, that each give a certain meaning through a combination of several words. It is possible to change the embodiments of the present invention as appropriate without departing from the scope of the technical idea described in the appended claims.

1. An abstract generation method of generating an abstract from document information, comprising:
extracting each sentence containing a keyword as a key-sentence from among sentences contained in the document information;
comparing a key-sentence and another key-sentence with each other and judging whether a part of the key-sentence matches the other key-sentence;
setting a summary candidate in accordance with a result of the judgment; and
generating an abstract based on each part of the document information corresponding to the summary candidate, wherein when it is judged that a part of the key-sentence matches the other key-sentence, a character string in the matching part is set as the summary candidate, and
when it is not judged that a part of the key-sentence matches the other key-sentence, the key-sentence is set as the summary candidate.

2. An abstract generation method according to claim 1,
wherein it is judged whether a part of the key-sentence matches a whole of the other key-sentence.

3. An abstract generation method according to claim 1,
wherein when it is judged that a part of the key-sentence matches the other key-sentence, a number of characters in the matching part is compared with a threshold value and, when the number of characters is less than the threshold value, the character string in the matching part is not set as the summary candidate but the key-sentence is set as the summary candidate.

4. An abstract generation method according to claim 1,
wherein when it is judged that a part of the key-sentence matches the other key-sentence, a number of morphemes in the matching part is compared with a threshold value and, when the number of morphemes is less than the threshold value, the character string in the matching part is not set as the summary candidate but the key-sentence is set as the summary candidate.

5. An abstract generation method according to claim 1,
wherein the document information is displayed in its entirety and also each character string part corresponding to the summary candidate is marked.

6. An abstract generation method of generating an abstract from document information, comprising:
comparing one sentence and another sentence contained in the document information with each other and judging whether a part of the sentence matches the other sentence;
setting a simplified sentence candidate in accordance with a result of the judgment;
extracting each simplified sentence candidate containing a keyword from among simplified sentence candidates and setting the extracted simplified sentence candidate as a summary candidate; and
generating an abstract based on each part of the document information corresponding to the summary candidate,
wherein when it is judged that a part of the sentence matches the other sentence, a character string in the matching part is set as the simplified sentence candidate, and
when it is not judged that a part of the sentence matches the other sentence, the sentence is set as the simplified sentence candidate.

7. An abstract generation method according to claim 6,
wherein it is judged whether a part of the key-sentence matches a whole of the other key-sentence.

8. An abstract generation method according to claim 6,
wherein when it is judged that a part of the key-sentence matches the other key-sentence, a number of characters in the matching part is compared with a threshold value and, when the number of characters is less than the threshold value, the character string in the matching part is not set as the simplified sentence candidate but the key-sentence is set as the simplified sentence candidate.

9. An abstract generation method according to claim 6,
wherein when it is judged that a part of the key-sentence matches the other key-sentence, a number of morphemes in the matching part is compared with a threshold value and, when the number of morphemes is less than the threshold value, the character string in the matching part is not set as the simplified sentence candidate but the key-sentence is set as the simplified sentence candidate.

10. An abstract generation method according to claim 6,
wherein the document information is displayed in its entirety and also each character string part corresponding to the summary candidate is marked.

11. A program product that gives a summary generation function to a computer, comprising:
an extraction processing portion that extracts each sentence containing a keyword as a key-sentence from among sentences contained in document information;
a judgment processing portion that compares a key-sentence and another key-sentence with each other and judges whether a part of the key-sentence matches the other key-sentence;
a setting processing portion that sets a summary candidate in accordance with a result of the judgment by the judgment processing portion; and
a generation processing portion that generates an abstract based on each part of the document information corresponding to the summary candidate set in the setting processing portion,
wherein the setting processing portion includes processing that
sets, when the judgment processing portion has judged that apart of the key-sentence matches the other key-sentence, a character string in the matching part as the summary candidate, and
sets, when the judgment processing portion has not judged that a part of the key-sentence matches the other key-sentence, the key-sentence as the summary candidate.

12. A program product according to claim 11,
wherein the setting processing portion includes processing that judges whether a part of the key-sentence matches a whole of the other key-sentence.

13. A program product according to claim 11,
wherein the setting processing portion includes processing that, when the judgment processing portion has judged that a part of the key-sentence matches the other key-sentence, compares a number of characters in the matching part with a threshold value and, when the number of characters is less than the threshold value, does not set the character string in the matching part as the summary candidate but sets the key-sentence as the summary candidate.

14. A program product according to claim 11,
wherein the setting processing portion includes processing that, when the judgment processing portion has judged that a part of the key-sentence matches the other key-sentence, compares a number of morphemes in the matching part with a threshold value and, when the number of morphemes is less than the threshold value, does not set the character string in the matching part as the summary candidate but sets the key-sentence as the summary candidate.

15. A program product according to claim 11,
wherein the generation processing portion includes processing that displays the document information in its entirety and also marks each character string part corresponding to the summary candidate set by the setting processing portion.

16. A program product that gives a summary generation function to a computer, comprising:
a judgment processing portion that compares a sentence and another sentence contained in document information and judges whether a part of the sentence matches the other sentence;
a simplification processing portion that sets a simplified sentence candidate in accordance with a result of the judgment by the judgment processing portion;
a setting processing portion that extracts each simplified sentence candidate containing a keyword from among simplified sentence candidates set by the simplification processing portion and sets the extracted simplified sentence candidate as a summary candidate; and
a generation processing portion that generates an abstract based on each part of the document information corresponding to the summary candidate set by the setting processing portion,
wherein the simplification processing portion includes processing that
sets, when the judgment processing portion has judged that a part of the sentence matches the other sentence, a character string in the matching part as the simplified sentence candidate, and
sets, when the judgment processing portion has not judged that a part of the sentence matches the other sentence, the sentence as the simplified sentence candidate.

17. A program product according to claim 16,
wherein the judgment processing portion includes processing that judges whether a part of the sentence matches a whole of the other sentence.

18. A program product according to claim 16,
wherein the simplification processing portion includes processing that, when the judgment processing portion has judged that a part of the sentence matches the other sentence, compares a number of characters in the matching part with a threshold value and, when the number of characters is less than the threshold value, does not set the character string in the matching part as the simplified sentence candidate but sets the sentence as the simplified sentence candidate.

19. A program product according to claim 16,
wherein the simplification processing portion includes processing that, when the judgment processing portion has judged that a part of the sentence matches the other sentence, compares a number of morphemes in the matching part with a threshold value and, when the number of morphemes is less than the threshold value, does not set the character string in the matching part as the simplified sentence candidate but sets the sentence as the simplified sentence candidate.

20. A program product according to claim 16,
wherein the generation processing portion includes processing that displays the document information in its entirety and also marks each character string part corresponding to the summary candidate set by the setting processing portion.
